(19) United States
(12) Patent Application Publication
(10) Pub. No.: US 2026/0056584 A1
(43) Pub. Date: Feb. 26, 2026

(54) ELECTRONIC DEVICE INCLUDING SUPPORT PLATE AND METHOD OF MANUFACTURING THE SUPPORT PLATE

(71) Applicant: Samsung Display Co., Ltd., Yongin-si (KR)

(72) Inventor: JOO-HAN BAE, Yongin-si (KR)

(21) Appl. No.: 19/297,861

(22) Filed: Aug. 12, 2025

(30) Foreign Application Priority Data
Aug. 26, 2024 (KR) 10-2024-0114424

(51) Int. Cl. G06F 1/16

(52) U.S. Cl. CPC G06F 1/1656; G06F 1/1641

(57) ABSTRACT

An electronic device includes: a display module including pixels and having a folding area and non-folding areas spaced apart from each other with the folding area therebetween and a support plate under the display module. The support plate includes an upper plate having first openings spaced apart from each other and defined through a portion thereof overlapping the folding area, a lower plate under the upper plate and having second openings spaced apart from each other and defined through a portion thereof overlapping the folding area, and an intermediate plate between the upper plate and the lower plate and including first and second parts spaced apart from each other at the folding area and respectively overlapping the non-folding areas.

### CROSS-REFERENCE TO RELATED APPLICATION

The present application claims priority to and the benefit of Korean Patent Application No. 10-2024-0114424, filed on Aug. 26, 2024, in the Korean Intellectual Property Office, the entire disclosure of which is incorporated herein by reference.

### BACKGROUND

### 1. Field

Aspects of embodiments of the present disclosure relate to an electronic device including a support plate and a method of manufacturing the support plate.

### 2. Description of Related Art

Various electronic devices that generate images and provide them to users through display screens, such as smartphones, digital cameras, notebook computers, navigation systems, and smart televisions, are being developed.

Recently, with technological advancements in electronic devices, various electronic devices are being developed. For example, various flexible electronic devices that are designed to be transformed (or bent) into curved shapes, folded, and/or rolled up are being developed. Flexible electronic devices are easy to carry and enhance user convenience.

### SUMMARY

Embodiments of the present disclosure provide an electronic device including a support plate that prevents foreign substances from entering a display module.

Embodiments of the present disclosure also provide a method of manufacturing the support plate included in the electronic device.

According to an embodiment of the present disclosure, an electronic device includes a display module including a folding area and non-folding areas spaced apart from each other with the folding area therebetween and including pixels and a support plate under the display module. The support place includes an upper plate having first openings spaced apart from each other and defined through a portion thereof overlapping the folding area, a lower plate under the upper plate and having second openings spaced apart from each other and defined through a portion thereof overlapping the folding area, and an intermediate plate between the upper plate and the lower plate and including first and second parts spaced apart from each other at the folding area and respectively overlapping the non-folding areas.

A side surface of the first part adjacent to the folding area and a side surface of the second part adjacent to the folding area may face each other.

A lower surface of the upper plate and an upper surface of the lower plate may face each other in the folding area, and the first part may have the same thickness as the second part.

The intermediate plate may not overlap the folding area.

The first openings may extend through an upper surface and a lower surface of the upper plate, and the second openings may extend through an upper surface and a lower surface of the lower plate.

The lower plate may include a first metal material, the intermediate plate may include a second metal material, the upper plate may include a third metal material. The second metal material may be different from the first metal material and the third metal material.

The first metal material and the third metal material may include the same material.

Each of the first metal material and the third metal material may include stainless steel or titanium, and the second metal material may include aluminum or copper.

The intermediate plate may be directly on the lower plate, and the upper plate may be directly on the intermediate plate.

A lower surface of the lower plate may be flat at an area overlapping the non-folding areas.

The electronic device may further include a plate adhesive layer between the display module and the support plate.

The support plate may be attached to a lower surface of the display module by the plate adhesive layer.

The plate adhesive layer may cover the first openings.

The first openings may not overlap the second openings when viewed in a plane.

The electronic device may further include a first intermediate adhesive layer between the lower plate and the intermediate plate and a second intermediate adhesive layer between the intermediate plate and the upper plate.

According to another embodiment of the present disclosure, an electronic device includes a display module including a folding area extending in a first direction when viewed in a plane and non-folding areas spaced apart from each other with the folding area therebetween in a second direction perpendicular the first direction and a support plate. The support plate includes an upper plate having first openings defined through a portion thereof overlapping the folding area along a third direction perpendicular to the first and second directions, a lower plate having second openings defined through a portion thereof overlapping the folding area along the third direction, and an intermediate plate between the upper plate and the lower plate and having a penetration portion extending through a portion thereof overlapping the folding area in the first direction from one side surface of the intermediate plate to another side surface thereof.

The lower plate may include a first metal material, the intermediate plate may include a second metal material, the upper plate may include a third metal material. The second metal material may be different from the first metal material and the third metal material.

The penetration portion may have a rectangular shape when viewed from the one side surface.

According to another embodiment of the present disclosure, a method of manufacturing a support plate includes forming a preliminary plate by sequentially stacking and pressing a preliminary upper plate including a first metal material, a preliminary intermediate plate including a second metal material different from the first metal material, and a preliminary lower plate including a third metal material different from the second metal material, attaching photosensitive films on upper and lower surfaces of the preliminary plate, respectively, forming film openings spaced apart from each other through the photosensitive films, and etching the preliminary plate by using an etchant.

An etch rate of the second metal material with respect to the etchant may be greater than an etch rate of the first metal material with respect to the etchant and an etch rate of the third metal material with respect to the etchant.

Each of the first metal material and the third metal material may include stainless steel or titanium, and the second metal material may include aluminum or copper.

The electronic device, according to embodiments of the present disclosure, includes the support plate that prevents foreign substances from entering the display module and prevents impacts from being transmitted to components above the support plate.

According to embodiments of the present disclosure, the support plate has a simplified structure and a reduced thickness, and it is easy to adjust the rigidity of the support plate. Thus, the folding reliability of the electronic device including the support plate is improved, and the thickness of the electronic device is reduced.

According to embodiments of the present disclosure, because the manufacturing process is simplified, the manufacturing cost and time for the support plate is reduced.

### BRIEF DESCRIPTION OF THE DRAWINGS

The above and other aspects and features of the present disclosure will become readily apparent by reference to the following detailed description when considered in conjunction with the accompanying drawings, in which:

FIGS. 1A to 1C are perspective views of an electronic device according to an embodiment of the present disclosure;

FIG. 2 is an exploded perspective view of an electronic device according to an embodiment of the present disclosure;

FIG. 3 is a block diagram of an electronic device according to an embodiment of the present disclosure;

FIG. 4 is a cross-sectional view of a display module taken along the line I-I′ in FIG. 2;

FIG. 5 is a plan view of a display module according to an embodiment of the present disclosure;

FIG. 6 is a perspective view of a support plate according to an embodiment of the present disclosure;

FIG. 7 is an enlarged cross-sectional view of the area AA′ in FIG. 6;

FIG. 8 is a cross-sectional view of a support plate according to an embodiment of the present disclosure;

FIG. 9 is a cross-sectional view of a support plate according to an embodiment of the present disclosure;

FIGS. 10 and 11 are cross-sectional views of a support plate according to an embodiment of the present disclosure;

FIGS. 12 to 14 are cross-sectional views of a support plate according to an embodiment of the present disclosure;

FIG. 15 is a flowchart describing a method of manufacturing a support plate according to an embodiment of the present disclosure;

FIGS. 16 to 20 are views of steps of a method of manufacturing a support plate according to an embodiment of the present disclosure; and

FIGS. 21A and 21B are perspective views of an electronic device according to an embodiment of the present disclosure.

### DETAILED DESCRIPTION

The present disclosure may be variously modified and realized in many different forms and, thus, only some example embodiments will be shown in the drawings and described in detail hereinbelow. However, the present disclosure should not be limited to the specific disclosed forms and should be construed to include all modifications, equivalents, or replacements included in the spirit and scope of the present disclosure.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to accompanying drawings.

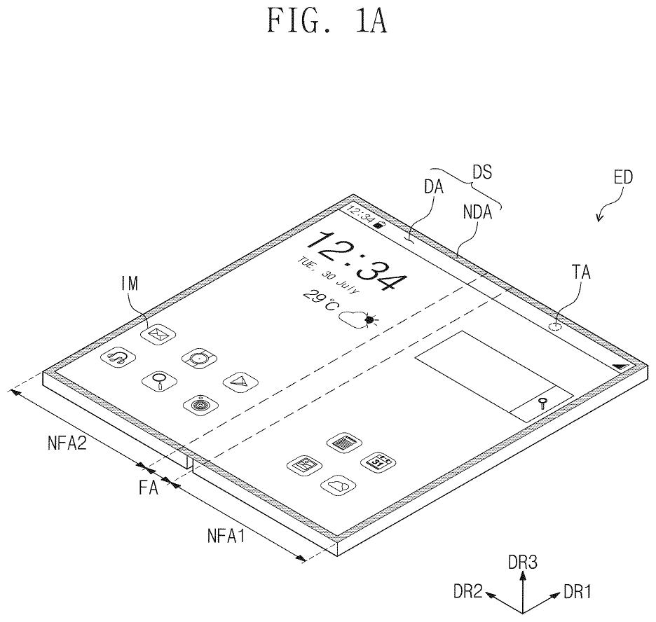

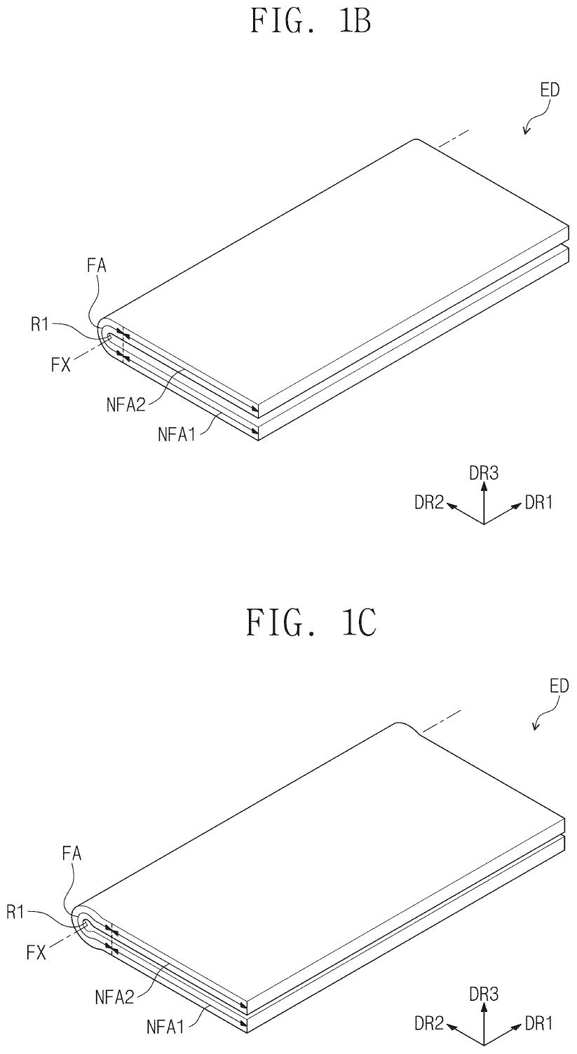

FIGS. 1A to 1C are perspective views of an electronic device ED according to an embodiment of the present disclosure.

FIG. 1A shows the electronic device ED in an unfolded state, and FIGS. 1B and 1C show the electronic device ED in a folded state.

Referring to FIGS. 1A to 1C, the electronic device ED may have a display surface DS defined by a first direction DR1 and a second direction DR2 crossing (or intersecting) the first direction DR1. The electronic device ED may provide (e.g., may emit) an image IM to a user through the display surface DS.

The display surface DS may have a display area DA and a non-display area NDA around the display area DA. The non-display area NDA may surround (e.g., may extend around a periphery of) the display area DA as shown in FIG. 1A, however, the present disclosure is not limited thereto or thereby. In another embodiment, the non-display area NDA may be defined adjacent to one side of the display area DA.

The display area DA may display the image IM, and the non-display area NDA may not display the image IM.

The display surface DS may have a sensing area TA. The sensing area TA may be a portion of (e.g., may overlap a portion of or may be arranged within) the display area DA. The sensing area TA may have a transmittance (e.g., a light transmittance) higher than that of other area(s) of the display area DA. Hereinafter, the other area(s) of the display area DA except for the sensing area TA may be referred to as the “ordinary display area.”

An optical signal (e.g., a visible light or an infrared light) may pass through the sensing area TA. The electronic device ED may take a picture of an external object by using (or according to) visible light passing through the sensing area TA and/or may determine whether or not an external object is approaching the electronic device ED by using (or according to) infrared light passing through the sensing area TA. FIG. 1A illustrates an embodiment having one sensing area TA as a representative example; however, the number of the sensing areas TA is not limited thereto or thereby. According to another embodiment, the sensing area TA may be provided in plural.

Hereinafter, a direction substantially perpendicular to a plane defined by the first direction DR1 and the second direction DR2 may be referred to as a third direction DR3. In the following descriptions, the third direction DR3 may correspond to a thickness direction of each member of the electronic device ED, and front and rear surfaces of each member of the electronic device ED may be distinguished from each other with respect to the third direction DR3. In the present disclosure, the expression “when viewed in a plane” may mean a state of being viewed in the third direction DR3.

The electronic device ED may have a folding area FA and a plurality of non-folding areas NFA1 and NFA2. The non-folding areas NFA1 and NFA2 may include a first non-folding area NFA1 and a second non-folding area NFA2. The first non-folding area NFA1 and the second non-folding area NFA2 may be spaced apart from each other with the folding area FA interposed therebetween.

As shown in FIG. 1B, the folding area FA may be folded with respect to a folding axis FX, which is substantially parallel to the first direction DR1. The folding area FA may have a curvature (e.g., a predetermined curvature) and a radius of curvature (e.g., a predetermined radius of curvature) R1.

The electronic device ED may be inwardly folded (referred to as inner-folding) such that the first non-folding area NFA1 faces the second non-folding area NFA2 and the display surface DS is not exposed to the outside. According to another embodiment, the electronic device ED may be outwardly folded (referred to as outer-folding) such that the display surface DS is exposed to the outside.

As shown in FIG. 1B, a distance between the first non-folding area NFA1 and the second non-folding area NFA2 may be substantially the same as the radius of curvature R1; however, the present disclosure is not limited thereto or thereby. As shown in FIG. 1C, the distance between the first non-folding area NFA1 and the second non-folding area NFA2 may be smaller than the radius of curvature R1.

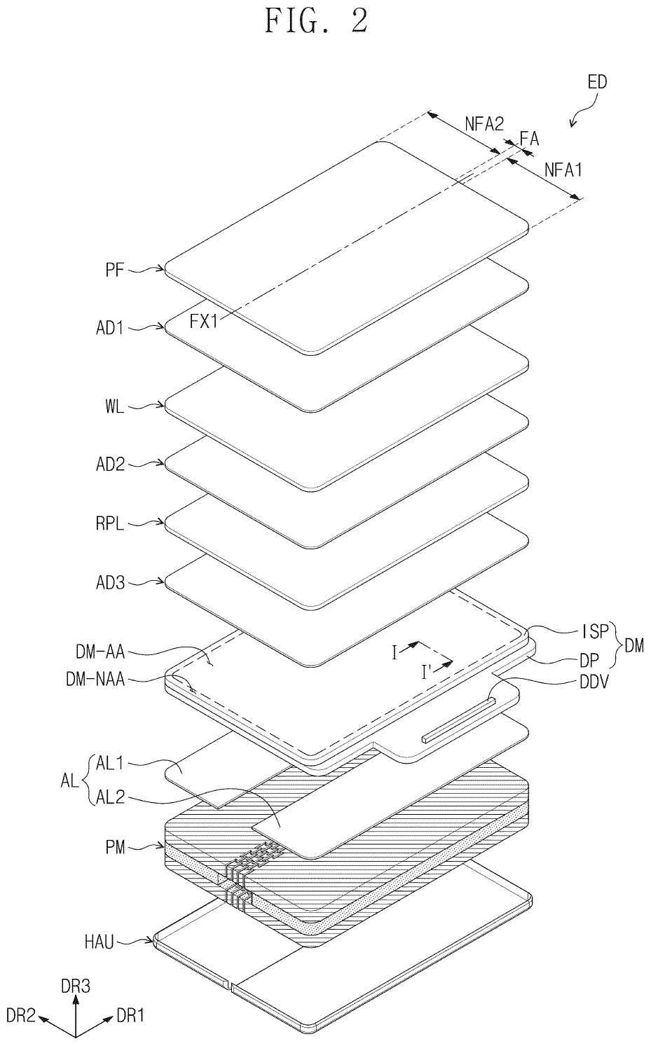

In an embodiment in which the distance between the first non-folding area NFA1 and the second non-folding area NFA2 is smaller than the radius of curvature R1, a reverse curvature portion may be formed in the folding area FA of the electronic device ED. Because it is relatively easy to adjust the rigidity of a support plate (see, e.g., PM in FIG. 2) according to embodiments of the present disclosure, cracks may not occur in the electronic device ED even when the reverse curvature portion is formed in this way. In addition, a thickness of the electronic device ED may be reduced in the folded state. Further details will be described later.

FIG. 2 is an exploded perspective view of the electronic device ED according to an embodiment of the present disclosure.

Referring to FIG. 2, the electronic device ED may include a protective layer PF, a window WL, an optical layer RPL, the display module DM, a support plate PM, and a housing HAU.

The housing HAU may be coupled with the protective layer PF to define an exterior of the electronic device ED. The housing HAU may include a material having relatively high rigidity. In an embodiment, the housing HAU may include a plurality of frames and/or plates formed of a glass, plastic, and/or a metal material. The housing HAU may provide (or may form) an accommodation space. The display module DM may be accommodated in the accommodation space and may be protected from external impacts.

The display module DM may be activated in response to electrical signals. The activated display module DM may display the image IM through the display area DA of the electronic device ED (see, e.g., FIG. 1A).

The display module DM may have a display area DM-AA and a non-display area DM-NAA defined therein. The display area DM-AA may be activated in response to electrical signals. The non-display area DM-NAA may be defined adjacent to at least one side of the display area DM-AA. Circuits or lines to drive the display area DM-AA may be arranged in the non-display area DM-NAA.

The optical layer RPL may be disposed between the display module DM and the window WL. The optical layer RPL may be an anti-reflective layer to reduce reflectance of the display module DM with respect to an external light incident to the display module DM from the outside. The optical layer RPL may be formed on the display module DM through successive processes. The optical layer RPL may include a polarizing plate and/or a color filter layer. In one embodiment, the optical layer RPL may include at least one of a retarder, a polarizer, a polarizing film, and a polarizing filter. According to an embodiment, the optical layer RPL may include a plurality of color filters arranged in a pattern and a black matrix disposed adjacent to the color filters.

The image IM generated by the display module DM may be provided to the user after passing through the window WL. The window WL may include an optically transparent insulating material. The window WL may include a polymer substrate or a glass substrate.

The window WL may include polyimide, polyacrylate, polymethylmethacrylate, polycarbonate, polyethylene naphthalate, polyvinylidene chloride, polyvinylidene difluoride, polystyrene, ethylene vinyl alcohol copolymer, or a combination thereof. However, this is merely an example, and the material of the window WL is not limited thereto or thereby. In another embodiment, the window WL may be a tempered glass substrate. The window WL may include ultra-thin glass (UTG).

The protective layer PF may act as a functional layer to protect one surface of the window WL. The protective layer PF may include a polymer film. The protective layer PF may include an anti-fingerprint coating agent, a hard coating agent, an anti-static agent, etc.

The support plate PM may be disposed under the display module DM. The support plate PM may prevent impacts occurring inside or outside the electronic device from being transmitted to components above the support plate PM or may prevent foreign substances from entering the components disposed above the support plate PM.

Different from a conventional support plate obtained by bonding multiple plates by using an adhesive, the support plate PM according to embodiments of the present disclosure may be formed by rolling and joining a plate having multiple openings defined in the folding area and a plate having portions spaced apart in the folding area. Accordingly, a structure of the support plate may be simplified, a surface quality of the support plate may be improved, and a manufacturing process of the support plate may be simplified. This will be described in more detail later.

The electronic device ED may further include at least one of a cushion layer or a shielding layer. The cushion layer may prevent the support plate PM from being pressed and deformed by external impact and force.

The electronic device ED may further include first, second, and third adhesive layers AD1, AD2, and AD3 and a plate adhesive layer AL. The first adhesive layer AD1 may be disposed between the window WL and the protective layer PF. The second adhesive layer AD2 may be disposed between the optical layer RPL and the window WL. The third adhesive layer AD3 may be disposed between the display module DM and the optical layer RPL. The plate adhesive layer AL may be disposed between the lower plate PM and the display module DM.

The first to third adhesive layers AD1 to AD3 and the plate adhesive layer AL may include a conventional adhesive, such as a pressure sensitive adhesive (PSA), an optically clear adhesive (OCA), an optical clear resin (OCR), or the like, but is not limited thereto.

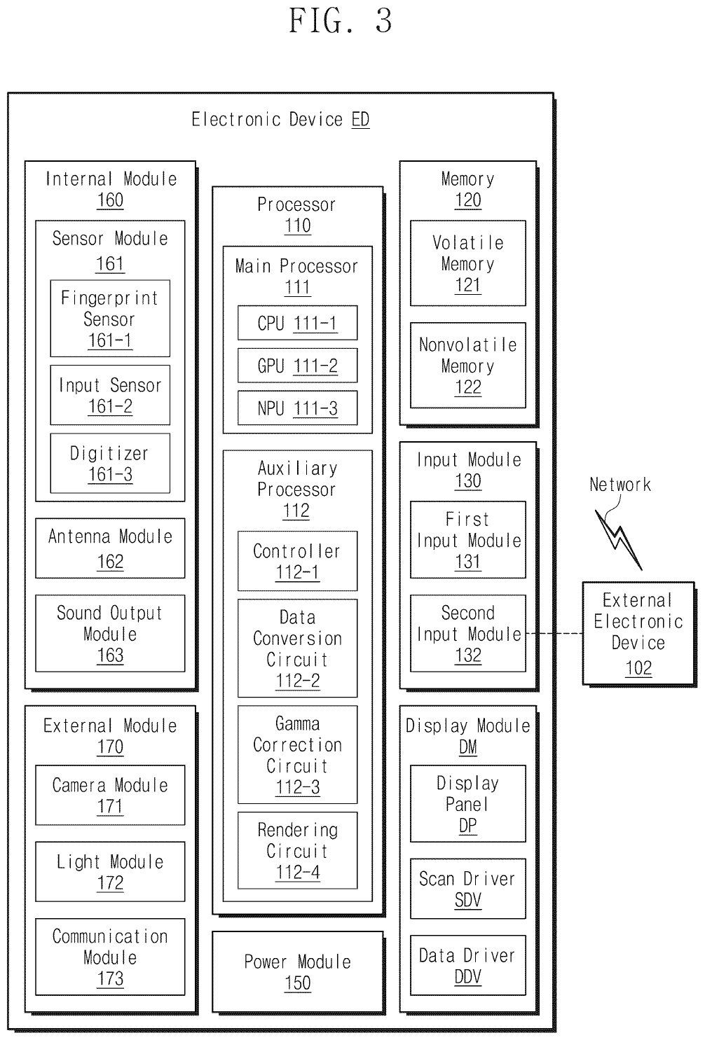

FIG. 3 is a block diagram of the electronic device according to an embodiment of the present disclosure.

Referring to FIG. 3, the electronic device ED may output various information through the display module DM within an operating system. When a processor 110 executes an application stored in a memory 120, the display module DM may provide application information to a user through a display panel DP.

The processor 110 may obtain an external input through an input module 130 or a sensor module 161 and may execute an application corresponding to the external input. For example, when the user selects a camera icon displayed on the display panel DP, the processor 110 may obtain a user input through an input sensor 161-2 and may activate a camera module 171. The processor 110 may transmit image data corresponding to a captured image obtained through the camera module 171 to the display module DM. The display module DM may display an image corresponding to the captured image through the display panel DP.

According to an embodiment, when personal information authentication is executed in the display module DM, a fingerprint sensor 161-1 may obtain input fingerprint information as input data. The processor 110 may compare input data obtained through the fingerprint sensor 161-1 with authentication data stored in the memory 120 and may execute an application according to the comparison result. The display module DM may display information executed according to a logic of the application through the display panel DP.

According to an embodiment, when a music streaming icon displayed on the display module DM is selected, the processor 110 may obtain a user input through the input sensor 161-2 and may activate a music streaming application stored in the memory 120. When a music execution command is input in the music streaming application, the processor 110 may activate a sound output module 163 to provide sound information corresponding to the music execution command to the user.

In the above, operation of the electronic device ED is briefly described. Hereinafter, a configuration of the electronic device ED is described in detail. Some of configurations of the electronic device ED to be described later may be integrated and provided as one configuration, and one configuration may be separated into two or more configurations and provided.

Referring to FIG. 3, the electronic device ED may communicate with an external electronic device 102 through a network (e.g., a short-range wireless communication network or a long-range wireless communication network). According to an embodiment, the electronic device ED may include the processor 110, the memory 120, an input module 130, the display module DM, a power module 150, an internal module 160, and an external module 170. According to an embodiment, in the electronic device ED, at least one of the above-described components may be omitted or one or more other components may be added. According to an embodiment, some of the above-described components (e.g., the sensor module 161, an antenna module 162, or the sound output module 163) may be integrated into another component (e.g., the display module DM).

The processor 110 may execute software to control at least another component (e.g., a hardware or software component) of the electronic device ED connected to the processor 110 and may perform various data processing or operations. According to an embodiment, as at least a portion of the data processing or operation, the processor 110 may store a command or data received from another component (e.g., the input module 130, the sensor module 161, or a communication module 173) in a volatile memory 121 and may process the command or the data stored in the volatile memory 121, and result data may be stored in a nonvolatile memory 122.

The processor 110 may include a main processor 111 and an auxiliary processor 112. The main processor 111 may include one or more of a central processing unit (CPU) 111-1 or an application processor (AP). The main processor 111 may further include any one or more of a graphics processing unit (GPU) 111-2, a communication processor (CP), and an image signal processor (ISP). The main processor 111 may further include a neural processing unit (NPU) 111-3. The NPU is a processor specialized in processing an artificial intelligence model, and the artificial intelligence model may be generated through (or by using) machine learning. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), a deep Q-network, or a combination of two or more of the above but is not limited to the above-described example. Additionally or alternatively, the artificial intelligence model may include a software structure in addition to a hardware structure. At least two of the above-described processing units and processors may be implemented as one integrated configuration (e.g., a single chip), or each may be implemented as an independent configuration (e.g., a plurality of chips).

The auxiliary processor 112 may include a controller 112-1. The controller 112-1 may include an interface conversion circuit and a timing control circuit. The controller 112-1 may receive an image signal from the main processor 111, may convert a data format of the image signal to correspond to an interface specification with the display module DM, and may output image data. The controller 112-1 may output various control signals for driving the display module DM.

The auxiliary processor 112 may further include a data conversion circuit 112-2, a gamma correction circuit 112-3, a rendering circuit 112-4, and the like. The data conversion circuit 112-2 may receive the image data from the controller 112-1, may compensate for the image data to display an image with a desired luminance according to a characteristic of the electronic device ED, a setting of the user, or the like, or may convert the image data for reduction of power consumption, afterimage compensation, or the like. The gamma correction circuit 112-3 may convert the image data, a gamma reference voltage, or the like so that the image displayed on the electronic device ED has a desired gamma characteristic. The rendering circuit 112-4 may receive the image data from the controller 112-1 and may render the image data in consideration of a pixel arrangement or the like of the display panel DP applied to the electronic device ED. At least one of the data conversion circuit 112-2, the gamma correction circuit 112-3, and the rendering circuit 112-4 may be integrated into another component (e.g., the main processor 111 or the controller 112-1). At least one of the data conversion circuit 112-2, the gamma correction circuit 112-3, and the rendering circuit 112-4 may be integrated into a data driver DDV to be described later.

The memory 120 may store various data used by at least one component (e.g., the processor 110 or the sensor module 161) of the electronic device ED and may input data or output data for a command related thereto. The memory 120 may include at least one of the volatile memory 121 and the nonvolatile memory 122.

The input module 130 may receive a command or data to be used by a component (e.g., the processor 110, the sensor module 161, or the sound output module 163) of the electronic device ED from an outside (e.g., the user or the external electronic device 102) of the electronic device ED.

The input module 130 may include a first input module 131 to which a command or data is input from the user and a second input module 132 to which a command or data is input from the external electronic device 102. The first input module 131 may include a microphone, a mouse, a keyboard, a key (e.g., a button), or a pen (e.g., a passive pen or an active pen). The second input module 132 may support a protocol capable of connecting to the external electronic device 102 by wire or wirelessly. According to an embodiment, the second input module 132 may include a high definition multimedia interface (HDMI), a universal serial bus (USB) interface, an SD card interface, or an audio interface. The second input module 132 may include a connector capable of physically connecting to the external electronic device 102, for example, an HDMI connector, a USB connector, an SD card connector, or an audio connector (e.g., a headphone connector).

The display module DM may visually provide information to the user. The display module DM may include a display panel DP, a scan driver SDV, and a data driver DDV. The display module DM may further include a window, a chassis, and a bracket to protect the display panel DP.

The display panel DP may include a liquid crystal display panel, an organic light emitting display panel, or an inorganic light emitting display panel, but a type of the display panel DP is not particularly limited. The display panel DP may be rigid or flexible, which may be rolled or folded. The display module DM may further include a supporter, a bracket, a heat dissipation member, or the like that supports the display panel DP.

The scan driver SDV may be mounted on the display panel DP as a driving chip. In addition, the scan driver SDV may be integrated in the display panel DP. For example, the scan driver SDV may include an amorphous silicon TFT gate driver circuit (ASG), a low temperature polycrystalline silicon (LTPS) TFT gate driver circuit, or an oxide semiconductor TFT gate driver circuit (OSG) built in the display panel DP. The scan driver SDV may receive a control signal from the controller 112-1 and may output scan signals to the display panel DP in response to the control signal.

The display panel DP may further include an emission driver. The emission driver may output an emission control signal to the display panel DP in response to a control signal received from the controller 112-1. The emission driver may be formed separately from the scan driver SDV or may be integrated into the scan driver SDV.

The data driver DDV may receive a control signal from the controller 112-1, may convert image data into an analog voltage (e.g., a data voltage) in response to the control signal, and may then output the data voltages to the display panel DP.

The data driver DDV may be integrated into another component (e.g., the controller 112-1). A function of the interface conversion circuit and the timing control circuit of the controller 112-1 described above may be integrated into the data driver DDV.

The display module DM may further include an emission driver, a voltage generation circuit, and the like. The voltage generation circuit may output various voltages necessary for driving the display panel DP.

The power module 150 may supply power to components of the electronic device ED. The power module 150 may include a battery that charges (or provides) a power voltage. The battery may include a non-rechargeable (or primary) cell, a rechargeable (or secondary) cell, or a fuel cell. The power module 150 may include a power management integrated circuit (PMIC). The PMIC may supply optimized power to each of the above-described module and a module to be described later. The power module 150 may include a wireless power transmission/reception member electrically connected to the battery. The wireless power transmission/reception member may include a plurality of antenna radiators of a coil form.

The electronic device ED may further include the internal module 160 and the external module 170. The internal module 160 may include the sensor module 161, the antenna module 162, and the sound output module 163. The external module 170 may include the camera module 171, a light module 172, and the communication module 173.

The sensor module 161 may sense an input by a body of the user or an input by a pen from among the first input module 131 and may generate an electrical signal or a data value corresponding to the input. The sensor module 161 may include at least one of a fingerprint sensor 161-1, an input sensor 161-2, and a digitizer 161-3.

The fingerprint sensor 161-1 may generate a data value corresponding to a fingerprint of the user. The fingerprint sensor 161-1 may include any one of an optical fingerprint sensor or a capacitive fingerprint sensor.

The input sensor 161-2 may generate a data value corresponding to coordinate information of the input by the body of the user or the pen. The input sensor 161-2 may generate a capacitance change amount by the input as the data value. The input sensor 161-2 may sense an input by the passive pen or may transmit/receive data to and from the active pen.

The input sensor 161-2 may measure a biometric signal, such as blood pressure, water, or body fat. For example, when the user touches a sensor layer or a sensing panel with a body part and does not move during a certain time, the input sensor 161-2 may sense the biometric signal based on a change of an electric field by the body part and may output information desired by the user to the display module DM.

The digitizer 161-3 may generate a data value corresponding to coordinate information of the input by the pen. The digitizer 161-3 may generate an electromagnetic change amount by the input as the data value. The digitizer 161-3 may sense the input by the passive pen or may transmit/receive data to and from the active pen.

At least one of the fingerprint sensor 161-1, the input sensor 161-2, and the digitizer 161-3 may be implemented as the sensor layer formed on the display panel DP through a continuous process. The fingerprint sensor 161-1, the input sensor 161-2, and the digitizer 161-3 may be disposed above the display panel DP, and any one of the fingerprint sensor 161-1, the input sensor 161-2, and the digitizer 161-3, for example, the digitizer 161-3 may be disposed below the display panel DP.

At least two of the fingerprint sensor 161-1, the input sensor 161-2, and the digitizer 161-3 may be formed to be integrated into one sensing panel through the same process. When at least two of the fingerprint sensor 161-1, the input sensor 161-2, and the digitizer 161-3 are integrated into one sensing panel, the sensing panel may be disposed between the display panel DP and a window disposed above the display panel DP. According to an embodiment, the sensing panel may be disposed on the window, but a position of the sensing panel is not particularly limited.

At least one of the fingerprint sensor 161-1, the input sensor 161-2, and the digitizer 161-3 may be embedded in the display panel DP. For example, at least one of the fingerprint sensor 161-1, the input sensor 161-2, and the digitizer 161-3 may be concurrently (or simultaneously) formed through a process of forming elements (e.g., a light emitting element, a transistor, and the like) included in the display panel DP.

In addition, the sensor module 161 may generate an electrical signal or a data value corresponding to an internal state or an external state of the electronic device ED. The sensor module 161 may further include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The antenna module 162 may include one or more antennas to transmit a signal or power to an outside or receive a signal or power from an outside. According to an embodiment, the communication module 173 may transmit a signal to an external electronic device or may receive a signal from an external electronic device through an antenna suitable for a communication method. An antenna pattern of the antenna module 162 may be integrated into one configuration (e.g., the display panel DP) of the display module DM or the input sensor 161-2.

The sound output module 163 is a device to output a sound signal to an outside of the electronic device ED and may include, for example, a speaker used for general purposes, such as multimedia playback or recording playback, and a receiver used to receive a call. According to an embodiment, the receiver may be formed integrally with or separately from the speaker. A sound output pattern of the sound output module 163 may be integrated into the display module DM.

The camera module 171 may capture a still image and a moving image. According to an embodiment, the camera module 171 may include one or more lenses, an image sensor, or an image signal processor. The camera module 171 may further include an infrared camera capable of measuring presence or absence of the user, a position of the user, a gaze of the user, and the like.

The light module 172 may provide light. The light module 172 may include a light emitting diode or a xenon lamp. The light module 172 may operate in conjunction with the camera module 171 or may operate independently.

The communication module 173 may support establishment of a wired or wireless communication channel between the electronic device ED and the external electronic device 102 and communication performance through the established communication channel. The communication module 173 may include any one or both of a wireless communication module, such as a cellular communication module, a short-range wireless communication module, or a global navigation satellite system (GNSS) communication module, and a wired communication module, such as a local area network (LAN) communication module or a power line communication module. The communication module 173 may communicate with the external electronic device 102 through a short-range communication network, such as Bluetooth, WiFi direct, or infrared data association (IrDA), or a long-range communication network, such as a cellular network, the Internet, or a computer network (e.g., LAN or WAN). The above-described various types of communication modules 173 may be implemented as a single chip or as separate chips.

The input module 130, the sensor module 161, the camera module 171, and the like may be used to control an operation of the display module DM in conjunction with the processor 110.

The processor 110 may output a command or data to the display module DM, the sound output module 163, the camera module 171, or the light module 172 based on input data received from the input module 130. For instance, the processor 110 may generate image data in response to the input data applied through a mouse, an active pen, or the like and output the image data to the display module DM, or may generate command data in response to the input data and output the command data to the camera module 171 or the light module 172. When the input data is not received from the input module 130 during (or within) a certain time, the processor 110 may convert an operation mode of the electronic device ED to a low power mode or a sleep mode to reduce power consumed in the electronic device ED.

The processor 110 may output a command or data to the display module DM, the sound output module 163, the camera module 171, or the light module 172 based on sensing data received from the sensor module 161. For instance, the processor 110 may compare authentication data applied by the fingerprint sensor 161-1 with authentication data stored in the memory 120 and may then execute an application according to a comparison result. The processor 110 may execute the command based on sensing data sensed by the input sensor 161-2 or the digitizer 161-3 or output corresponding image data to the display module DM. When the sensor module 161 includes a temperature sensor, the processor 110 may receive temperature data for a measured temperature from the sensor module 161 and further perform luminance correction or the like on the image data based on the temperature data.

The processor 110 may receive measurement data for the presence or absence of the user, the position of the user, the gaze of the user, and the like, from the camera module 171. The processor 110 may further perform luminance correction or the like on the image data based on the measurement data. For instance, the processor 110 may determine the presence or absence of the user through an input from the camera module 171 and may output image data of which a luminance is corrected through the data conversion circuit 112-2 or the gamma correction circuit 112-3 to the display module DM.

Some of the above-described components may be connected to each other through a communication method between peripheral devices, for example, a bus, general purpose input/output (GPIO), a serial peripheral interface (SPI), a mobile industry processor interface (MIPI), or an ultra path interconnect (UPI) link to exchange a signal (e.g., a command or data) with each other. The processor 110 may communicate with the display module DM through a mutually agreed interface, for example, any one of the above-described communication methods but is not limited to the above-described communication methods.

The electronic device ED according to various embodiments disclosed in the present disclosure may be various types of devices. The electronic device ED may include, for example, at least one of a portable communication device (e.g., a smartphone), a computer device, a portable multimedia device, a portable medical device, a camera, a wearable device, and a home appliance device. The electronic device ED according to embodiments of the present document should not be limited to the above-described devices.

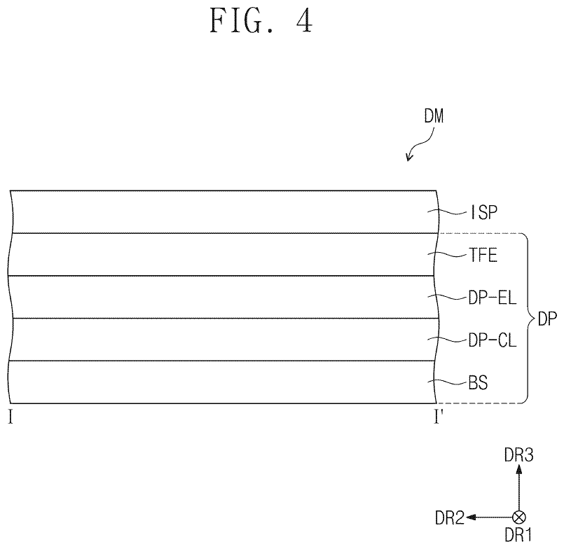

FIG. 4 is a cross-sectional view of the display module DM taken along the line I-I′ in FIG. 2.

Referring to FIG. 4, the display module DM may include the display panel DP and an input sensing layer ISP disposed on the display panel DP. The display panel DP may have a configuration that substantially generates the image. The display panel DP may be a light-emitting type display panel. For example, the display panel DP may be an organic light emitting display panel, an inorganic light emitting display panel, a micro-LED display panel, a micro-OLED display panel, or a nano-LED display layer.

The display panel DP may include a base layer BS, a circuit layer DP-CL, a display element layer DP-EL, and an encapsulation layer TFE, which are sequentially stacked. In another embodiment different from the structure of the display panel DP shown in FIG. 4, a functional layer may be disposed between two layers adjacent to each other from among the base layer BS, the circuit layer DP-CL, the display element layer DP-EL, and the encapsulation layer TFE.

The base layer BS may provide a base surface on which the circuit layer DP-CL is disposed. The base layer BS may be a flexible substrate that is bendable, foldable, or rollable. The base layer BS may be a glass substrate, a metal substrate, or a polymer substrate; however, it is not limited thereto or thereby. According to an embodiment, the base layer BS may be an inorganic layer, an organic layer, or a composite material layer.

The base layer BS may have a single-layer or multi-layer structure. For instance, the base layer BS may include a first synthetic resin layer, an inorganic layer having a single-layer or multi-layer structure, and a second synthetic resin layer disposed on the inorganic layer having the single-layer or multi-layer structure. Each of the first and second synthetic resin layers may include a polyimide-based resin. In addition, each of the first and second synthetic resin layers may include at least one of an acrylic-based resin, a methacrylic-based resin, a polyisoprene-based resin, a vinyl-based resin, an epoxy-based resin, a urethane-based resin, a cellulose-based resin, a siloxane-based resin, a polyamide-based resin, and a perylene-based resin. Meanwhile, in the present disclosure, the term “X-based resin”, as used herein, refers to the resin that includes a functional group of X.

The circuit layer DP-CL may be disposed on the base layer BS. The circuit layer DP-CL may include an insulating layer, a semiconductor pattern, a conductive pattern, and a signal line. The display element layer DP-EL may be disposed on the circuit layer DP-CL. The display element layer DP-EL may include a light emitting element. As an example, the light emitting element may include an organic light emitting material, an inorganic light emitting material, an organic-inorganic light emitting material, a quantum dot, a quantum rod, a micro-LED, or a nano-LED.

The encapsulation layer TFE may be disposed on the display element layer DP-EL. The encapsulation layer TFE may protect the display element layer DP-EL from moisture, oxygen, and foreign substances, such as dust particles. The encapsulation layer TFE may include at least one inorganic layer. As an example, the encapsulation layer TFE may include an inorganic layer, an organic layer, and an inorganic layer, which are sequentially stacked.

The input sensing layer ISP may be disposed on the display panel DP. The input sensing layer ISP may be disposed directly on the encapsulation layer TFE; however, the present disclosure is not limited thereto or thereby. According to an embodiment, an adhesive member may be disposed between the input sensing layer ISP and the display panel DP.

In the present disclosure, the expression one component being “disposed directly on” another component means that no third component is disposed between the component and the other component. For example, when one component is “directly disposed” on another component, it means that the one component and the other component are in “direct contact” each other.

The input sensing layer ISP may sense an external input, may convert the sensed input to an input signal (e.g., a predetermined input signal), and may provide the input signal to the display panel DP. In one embodiment, the input sensing layer ISP may be a touch sensing layer that senses a touch event. The input sensing layer ISP may sense a direct touch of the user, an indirect touch of the user, a direct touch of an object, or an indirect touch of an object.

The input sensing layer ISP may sense at least one of a position of a touch event applied from the outside and an intensity (e.g., pressure) of the touch event applied from the outside. The input sensing layer ISP may have various structures or may include various materials and is not particularly limited. As an example, the input sensing layer ISP may sense the external input in a capacitive manner. The display panel DP may receive the input signal from the input sensing layer ISP and may generate the image corresponding to the input signal.

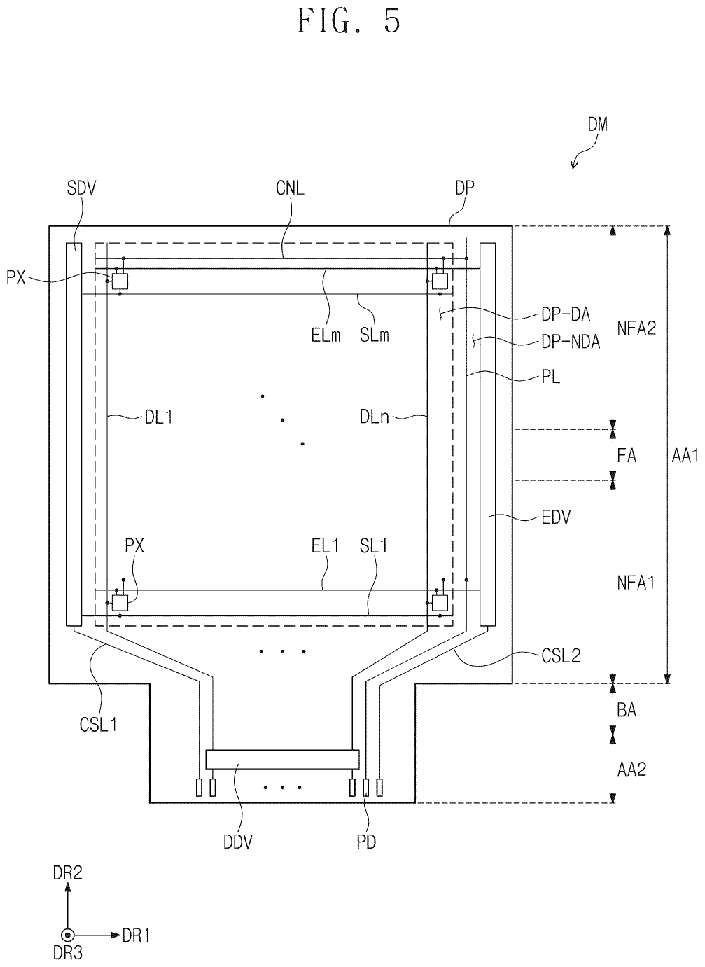

FIG. 5 is a plan view of the display module DM according to an embodiment of the present disclosure.

Referring to FIG. 5, the display panel DP may have a display area DP-DA and a non-display area DP-NDA around (e.g., around a periphery of) the display area DP-DA.

The display area DP-DA and the non-display area DP-NDA may be distinguished from each other depending on presence or absence of a pixel PX. The pixel PX may be disposed in the display area DP-DA. The scan driver SDV, the data driver, and the emission driver EDV may be disposed in the non-display area DP-NDA. The data driver may be a part of the driving chip DDV shown in FIG. 2.

The display panel DP may include a first area AA1, a second area AA2, and a bending area BA, which are distinguished from each other in the second direction DR2. The second area AA2 and the bending area BA may be a part of the non-display area DP-NDA. The bending area BA may be disposed between the first area AA1 and the second area AA2.

The first area AA1 may be an area corresponding to the display surface DS shown in FIG. 1A. The first area AA1 may include a first non-folding area NFA1, a second non-folding area NFA2, and a folding area FA.

The first non-folding area NFA1, the second non-folding area NFA2, and the folding area FA may correspond to the first non-folding area NFA1, the second non-folding area NFA2, and the folding area FA shown in FIGS. 1A to 1C, respectively, and may be assigned the same reference numerals.

A length of the bending area BA and the second area AA2 in the first direction DR1 may be smaller than a length of the first area AA1 in the first direction DR1. An area with a relatively short length in a bending axis direction may be easily bent.

The display panel DP may include a plurality of pixels PX, a plurality of scan lines SL1 to SLm, a plurality of data lines DL1 to DLn, a plurality of emission lines EL1 to ELm, first and second control lines CSL1 and CSL2, a power line PL, a plurality of connection lines CNL, and a plurality of pads PD. Each of m and n is a natural number. The pixels PX may be respectively connected to the scan lines SL1 to SLm, the data lines DL1 to DLn, and the emission lines EL1 to ELm.

The scan lines SL1 to SLm may extend in a direction parallel to the first direction DR1 and may be connected to the scan driver SDV. The data lines DL1 to DLn may extend in a direction parallel to the second direction DR2 and may be connected to the data driver DDV via the bending area BA. The emission lines EL1 to ELm may extend in the first direction DR1 and may be connected to the emission driver EDV.

The power line PL may include a portion extending in the second direction DR2 and a portion extending in the first direction DR1. The portion extending in the first direction DR1 and the portion extending in the second direction DR2 may be disposed on different layers from each other. The portion of the power line PL, which extends in the second direction DR2, may extend to the second area AA2 via the bending area BA. The power line PL may provide a first voltage to the pixels PX.

The first control line CSL1 may be connected to the scan driver SDV and may extend toward a lower end of the second area AA2 via the bending area BA. The second control line CSL2 may be connected to the emission driver EDV and may extend toward the lower end of the second area AA2 via the bending area BA.

When viewed in the plane, the pads PD may be disposed adjacent to the lower end of the second area AA2. The data driver DDV, the power line PL, the first control line CSL1, and the second control line CSL2 may be connected to the pads PD.

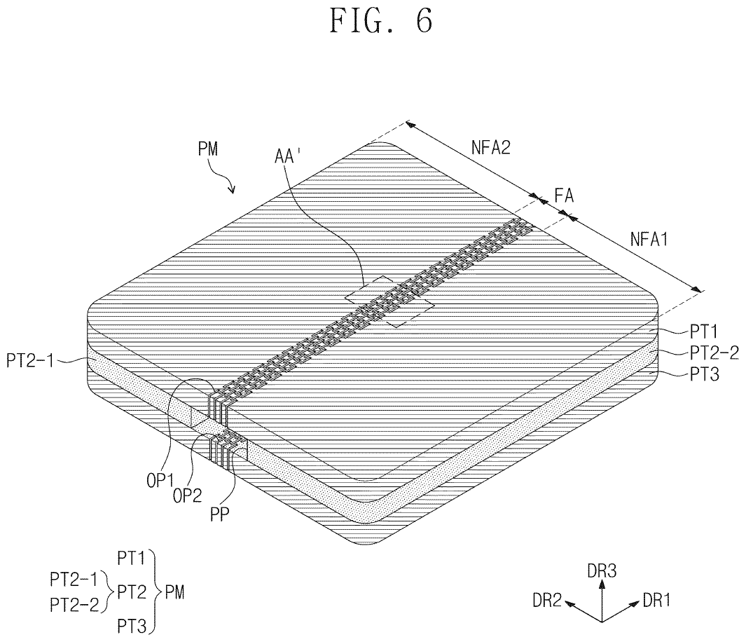

FIG. 6 is a perspective view of the support plate PM according to an embodiment of the present disclosure.

Referring to FIG. 6, the support plate PM may include an upper plate PT1, an intermediate plate PT2, and a lower plate PT3. The lower plate PT3, the intermediate plate PT2, and the upper plate PT1 may be sequentially stacked along the third direction DR3.

The upper plate PT1 may have first openings OP1 defined therethrough in the folding area FA. The first openings OP1 may be defined through (e.g., may extend through) upper and lower surfaces of the upper plate PT1. The first openings OP1 may be spaced apart from each other.

The lower plate PT3 may be disposed under the upper plate PT1. The lower plate PT3 may be spaced apart from the upper plate PT1 with the intermediate plate PT2 interposed therebetween.

The lower plate PT3 may have second openings OP2 defined therethrough in the folding area FA. The second openings OP2 may be defined through (e.g., may extend through) upper and lower surfaces of the lower plate PT3. The second openings OP2 may be spaced apart from each other.

The intermediate plate PT2 may be disposed under the upper plate PT1. The intermediate plate PT2 may be disposed on the lower plate PT3. For example, the intermediate plate PT2 may be disposed between the upper plate PT1 and the lower plate PT3.

The intermediate plate PT2 may include a first part PT2-1 and a second part PT2-2, which are spaced apart from each other at the folding area FA and respectively overlap the non-folding areas NFA2 and NFA1.

The intermediate plate PT2 may not overlap (e.g., may be offset from) the folding area FA.

In the present embodiment, the support plate PM may include a clad metal. For example, the support plate PM may be a member in which the plates PT1, PT2, and PT3 are rolled together, resulting in atomic diffusion bonding between different metals. In such an embodiment, the intermediate plate PT2 may become a base metal of the clad metal material, and the upper plate PT1 and the lower plate PT3 may be respectively rolled onto upper and lower surfaces of the intermediate plate PT2.

Accordingly, the support plate PM may have a single unitary form without a separated adhesive layer. For example, the upper plate PT1, the intermediate plate PT2, and the lower plate PT3 may be bonded to each other by the atomic diffusion bonding method without using a separate adhesive layer.

Therefore, the upper plate PT1 may be disposed directly on the intermediate plate PT2. In addition, the intermediate plate PT2 may be disposed directly on the lower plate PT3. Accordingly, compared with a conventional support plate obtained by (or formed by) bonding plates by using an adhesive, the upper plate PT1, the intermediate plate PT2, and the lower plate PT3 may not be easily detached from each other and may have excellent processing performance. However, the present disclosure is not limited thereto or thereby, and the upper plate PT1, the intermediate plate PT2, and the lower plate PT3 may be bonded to each other by a separate adhesive layer disposed therebetween. This will be described in detail later.

The upper plate PT1 may include a first metal material, the intermediate plate PT2 may include a second metal material, and the lower plate PT3 may include a third metal material. The second metal material may be different from the first metal material and the third metal material.

In the present embodiment, the first metal material and the third metal material may include the same material; however, the present disclosure is not limited thereto or thereby. According to an embodiment, the first metal material and the third metal material may include different materials. As an example, each of the first metal material and the third metal material may include stainless steel (SS) or titanium (Ti), and the second metal material may include aluminum (AI) or copper (Cu).

As described above, when the support plate PM employs a combination of the first to third metal materials, the support plate PM may provide adequate performance. For example, the first to third metal materials may be selected and combined in various ways to provide the designed performance.

As an example, when the first and third metal materials include stainless steel and the second metal material includes aluminum (or copper), the rigidity and surface quality of the support plate PM may be improved by stainless steel. In addition, the use of aluminum may enhance the heat dissipation performance of the support plate PM and may reduce its weight.

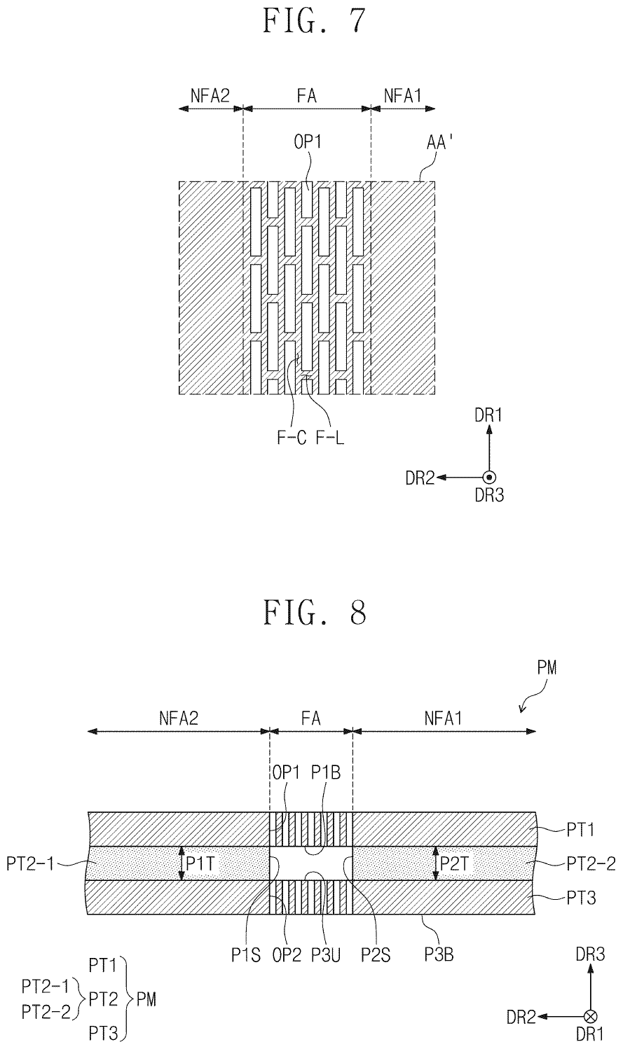

FIG. 7 is an enlarged cross-sectional view of the area AA′ in FIG. 6. Hereinafter, the characteristics of the first openings OP1 will be described with reference to FIG. 7.

Referring to FIG. 7, the first openings OP1 may be defined through the upper plate PT1 in the folding area FA. Accordingly, the upper plate PT1 may have improved flexibility in the folding area FA compared to the non-folding areas NFA1 and NFA2.

In the present embodiment, each of the first openings OP1 may have a rectangular shape extending in (e.g., having a length direction in) the first direction DR1.

The first openings OP1 may be arranged in the first direction DR1 and the second direction DR2. The first openings OP1 may be arranged in a zigzag pattern along the second direction DR2. Accordingly, the upper plate PT1 may have a grid shape in the folding area FA.

In the folding area FA, a portion of the upper plate PT1 except the first openings OP1 may be defined as a support portion. The support portion may include first extension portions F-C and second extension portions F-L; however, this is merely an example. According to an embodiment, the support portion may have a single unitary form.

The first extension portions F-C and the second extension portions F-L may define the grid pattern. The first extension portions F-C may be arranged to allow the first openings OP1 to be arranged in the zigzag pattern along the second direction DR2. The support portion may include the first extension portions F-C and the second extension portions F-L. The first extension portions F-C may extend in the first direction DR1 and may be arranged in the second direction DR2. Each of the second extension portions F-L may extend in the second direction DR2 and may be disposed between the first extension portions F-C adjacent to each other.

However, the present disclosure is not limited thereto or thereby. In another embodiment, the first openings OP1 may have a chamfered shape extending in the first direction DR1 or may have an oval shape.

Descriptions on the first openings OP1 with reference to FIG. 7 may be equally/similarly applied to the second openings OP2 (see, e.g., FIG. 6), and thus, details of the second openings OP2 will be omitted. However, the present disclosure should not be limited in which the number and/or shape of the first openings OP1 match the number and/or shape of the second openings OP2. In another embodiment, the number of first openings OP1 or the number of second openings OP2 may be greater than the other. In addition, the shape of the first openings OP1 may be different from the shape of the second openings OP2.

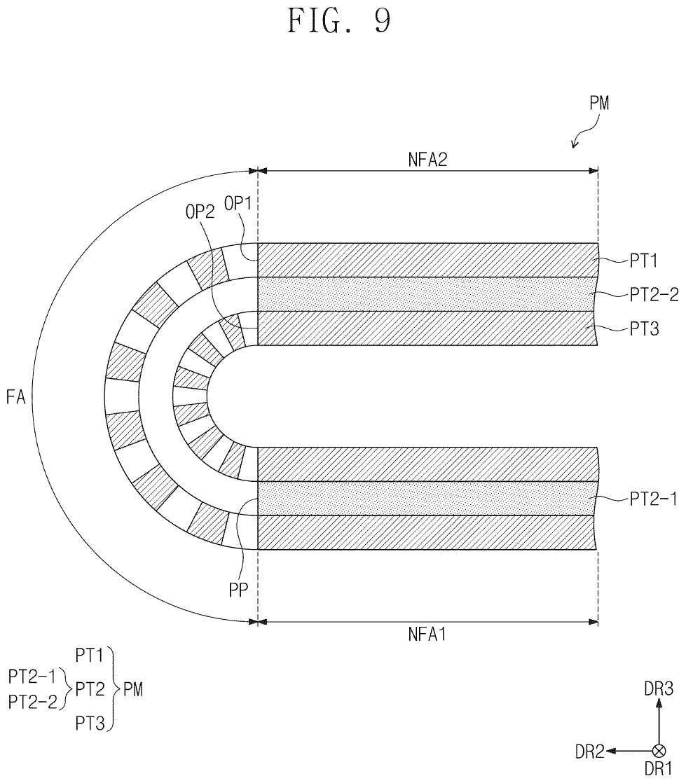

FIG. 8 is a cross-sectional view of the support plate PM according to an embodiment of the present disclosure, and FIG. 9 is a cross-sectional view of the support plate PM according to an embodiment of the present disclosure.

FIG. 8 shows the support plate PM in an unfolded state, and FIG. 9 shows the support plate PM in a folded state.

The intermediate plate PT2 may include the first part PT2-1 and the second part PT2-2.

The first part PT2-1 and the second part PT2-2 may be spaced apart from each other with the folding area FA interposed therebetween.

A side surface P1S of the first part PT2-1, which is adjacent to the folding area FA, and a side surface P2S of the second part PT2-2, which is adjacent to the folding area FA, may face each other.

In addition, a lower surface P1B of the upper plate and an upper surface P3U of the lower plate may face each other in the folding area FA.

Accordingly, a penetration portion PP may be defined by the side surface P1S of the first part PT2-1, the side surface P2S of the second part PT2-2, the lower surface P1B of the upper plate PT1, and the upper surface P3U of the lower plate PT3. When viewed from one side of the support plate PM in the first direction DR1, the penetration portion PP may have a rectangular shape.

Referring to FIG. 8, the lower surface P3B of the lower plate PT3 may be flat throughout the non-folding areas NFA1 and NFA2. For example, the lower surface P3B of the lower plate PT3 may be flat throughout portions overlapping the non-folding areas NFA1 and NFA2. Accordingly, a recessed or protruded portion may not be formed in the portions of the lower plate PT3 overlapping the non-folding areas NFA1 and NFA2. For example, the support plate PM according to the present embodiment may have a simplified structure compared with the conventional support plate.

The first part PT2-1 may have a thickness P1T that is the same as a thickness P2T of the second part PT2-2.

The support plate PM according to embodiments of the present disclosure may prevent foreign substances from entering the display module DM (see, e.g., FIG. 2).

According to embodiments of the present disclosure, the support plate PM may have a simplified structure, allowing for reduced thickness while still facilitating easy adjustment of rigidity. Accordingly, the folding reliability of the electronic device ED including the support plate PM may be improved, and the thickness of the electronic device ED may be reduced.

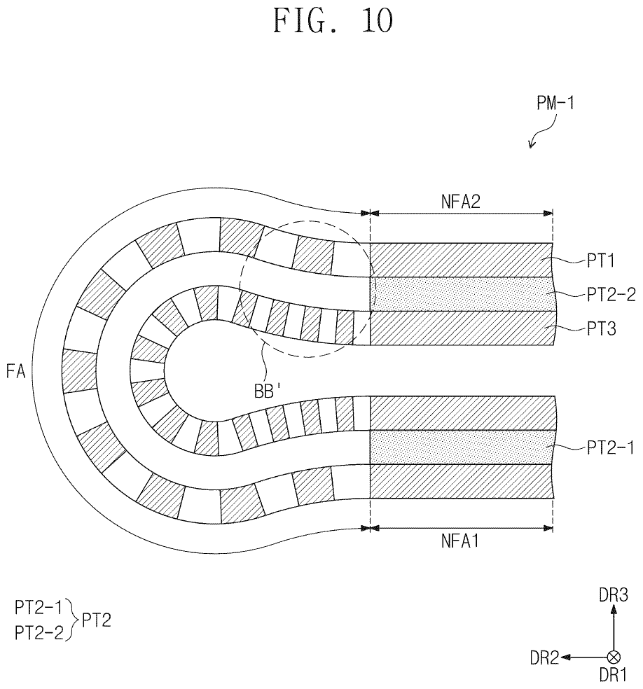

FIG. 10 is a cross-sectional view of a support plate PM-1 according to an embodiment of the present disclosure.

When the support plate PM-1 is folded, a reverse curvature portion is formed in the area BB′ in FIG. 10.

According to the support plate of a conventional foldable electronic device, a half-etching pattern is formed on a lower surface of the support plate to form the reverse curvature portion. That is, in a conventional support plate, a thickness of a portion at where a curvature occurs is reduced to decrease the rigidity of that portion. However, when the half-etching pattern is separately formed, the structure of the support plate becomes more complex, and additional processes are required.

Different from the conventional foldable electronic device, because the support plate PM according to embodiments of the present disclosure is formed by rolling and joining the plates PT1, PT2, and PT3, the support plate PM according to embodiments of the present disclosure may have a relatively small thickness compared with the conventional support plate, and the rigidity of the support plate PM may be easily controlled by adjusting the number of the openings OP1 and OP2 or the materials for the plates PT1, PT2, and PT3. Therefore, the reverse curvature portion may be easily formed without the separate half-etching pattern.

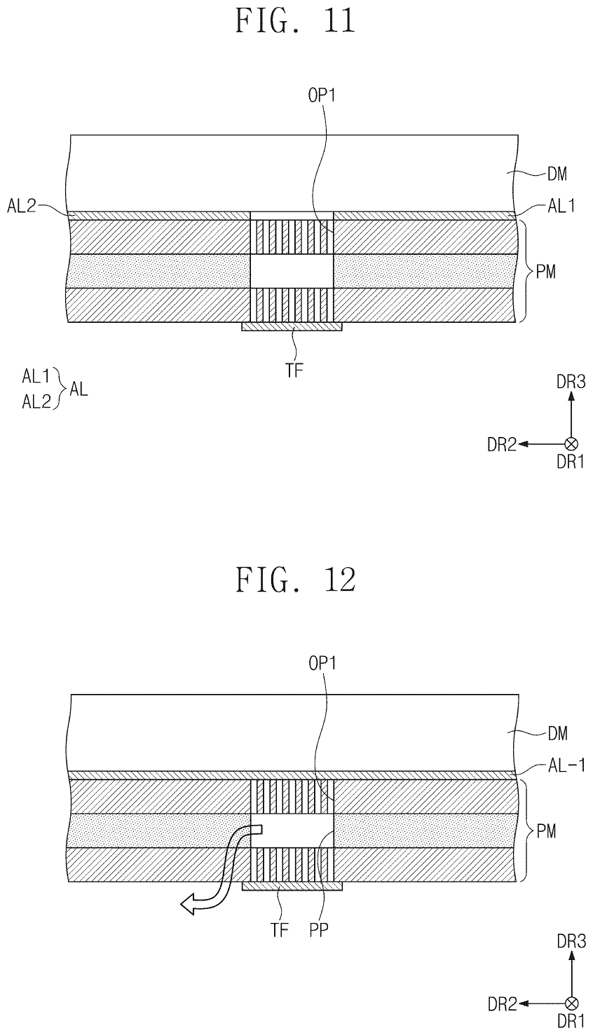

FIG. 11 is a cross-sectional view of the electronic device according to an embodiment of the present disclosure.

For the convenience of explanation, components of the electronic device (see, e.g., ED in FIG. 2) except the display module DM, the plate adhesive layer AL, the support plate PM, the lower film TF are omitted in FIG. 11.

Referring to FIG. 11, the plate adhesive layer AL may be disposed between the support plate PM and the display module DM. The support plate PM may be attached to a lower surface of the display module DM by the plate adhesive layer AL.

The plate adhesive layer AL may include the first adhesive layer AL1 and the second adhesive layer AL2. The first adhesive layer AL1 and the second adhesive layer AL2 may be spaced apart from each other with the folding area FA interposed therebetween. The plate adhesive layer AL may not cover the first openings OP1.

Referring to FIG. 11, the electronic device ED according to the present embodiment may further include the lower film TF disposed on the lower surface of the lower plate (see, e.g., PT3 in FIG. 6) to cover the second openings (see, e.g., OP2 in FIG. 6). The lower film TF may block (e.g., may directly block) foreign substances that may be introduced through the second openings OP2. The lower film TF may include a thermoplastic polyurethane polymer (TPU).

FIG. 12 is a cross-sectional view of a portion of an electronic device according to an embodiment of the present disclosure.

In FIG. 12, the same/similar reference numerals denote the same elements in FIGS. 1 to 11, and thus, detailed descriptions of the same elements will be omitted.

The electronic device according to the present embodiment may include a display module DM, a support plate PM disposed under the display module DM, a plate adhesive layer AL-1 disposed between the display module DM and the support plate PM, and a lower film TF covering a lower surface of the support plate PM.

In the present embodiment, the plate adhesive layer AL-1 may cover the first openings OP1. For example, the plate adhesive layer AL-1 may block the first openings OP1, which act as an air path through which gases are introduced and may prevent the gases from flowing in the third direction DR3.

According to a conventional support plate, when a plate adhesive layer completely covers an upper surface of the support plate through which openings are defined and a lower film covers a lower surface of the support plate through which openings are defined, the air path is completely blocked. In this case, when a pressure of gases trapped in openings changes (e.g., increases) during the manufacturing process of the electronic device, the plate adhesive layer or the lower film deforms due to the pressure and is visible from the outside of the electronic device.

Different from the conventional support plate, the support plate PM according to embodiments of the present disclosure may control the pressure by using a penetration portion PP even though the first openings OP1 are blocked by the plate adhesive layer AL-1 and second openings OP2 are blocked by the lower film TF.

For example, gases existing in the openings OP1 and OP2 may flow in the first direction DR1 through the penetration portion PP and may exit to the outside, and thus, the plate adhesive layer AL-1 or the lower film TF may be prevented from being deformed by the pressure.

In FIG. 12, the flow of the gas through the penetration portion PP is indicated by an arrow as a representative example.

FIG. 13 is a cross-sectional view of a portion of an electronic device according to an embodiment of the present disclosure.

In FIG. 13, the same/similar reference numerals denote the same elements in FIGS. 1 to 11, and thus, detailed descriptions of the same elements will be omitted.

The electronic device according to the present embodiment may include a display module DM, a support plate PM-1 disposed under the display module DM, and a plate adhesive layer AL disposed between the display module DM and the support plate PM-1.

In the present embodiment, first openings OP1-1 may not overlap (e.g., may be offset with respect to) second openings OP2-1 when viewed in the plane.

When viewed in the plane, the first openings OP1-1 may be positioned alternately with the second openings OP2-1. For example, in a folding area FA (see, e.g., FIG. 10), portions of an upper plate PT1-1 at where the first openings OP1-1 are not defined and portions of a lower plate PT3-1 at where the second openings OP2-1 are not defined may be positioned alternately when viewed in the plane.

FIG. 13 shows a structure in which the first openings OP1-1 do not overlap the second openings OP2-1 as indicated by dashed lines as a representative example.

When viewed from a lower side of the support plate PM-1 in the third direction DR3, the first openings OP1-1 of the upper plate PT1-1 may not be viewed through the second openings OP2-1 of the lower plate PT3. That is, only portions of the upper plate PT1-1 where the first openings OP-1 are not defined may be viewed through the second openings OP2-1.

Accordingly, an inflow path for foreign substances that enter from a lower surface of the support plate PM-1 and must pass through the second openings OP2-1 and through the first openings OP1-1 may become more complicated. Accordingly, even when a separate lower film (see, e.g., TF in FIG. 11) is not provided, the support plate PM-2 may block the foreign substances from being introduced through the lower side of the support plate PM-2 in the third direction DR3.

FIG. 13 shows a structure in which the foreign substances passing through the second openings OP2-1 are blocked by the upper plate PT1 and do not pass through the first openings OP1-1 as indicated by an arrow.

The support plate PM-1 according to the present embodiment may have the openings OP1-1 and OP2-1, which are defined therethrough, and a penetration portion PP. Accordingly, the folding characteristic in the folding area FA may be improved, and the thickness of the electronic device may be reduced because the lower film TF (see, e.g., FIG. 11) is omitted. Thus, the thickness of the electronic device may be reduced, and the manufacturing cost and time for the electronic device may be reduced.

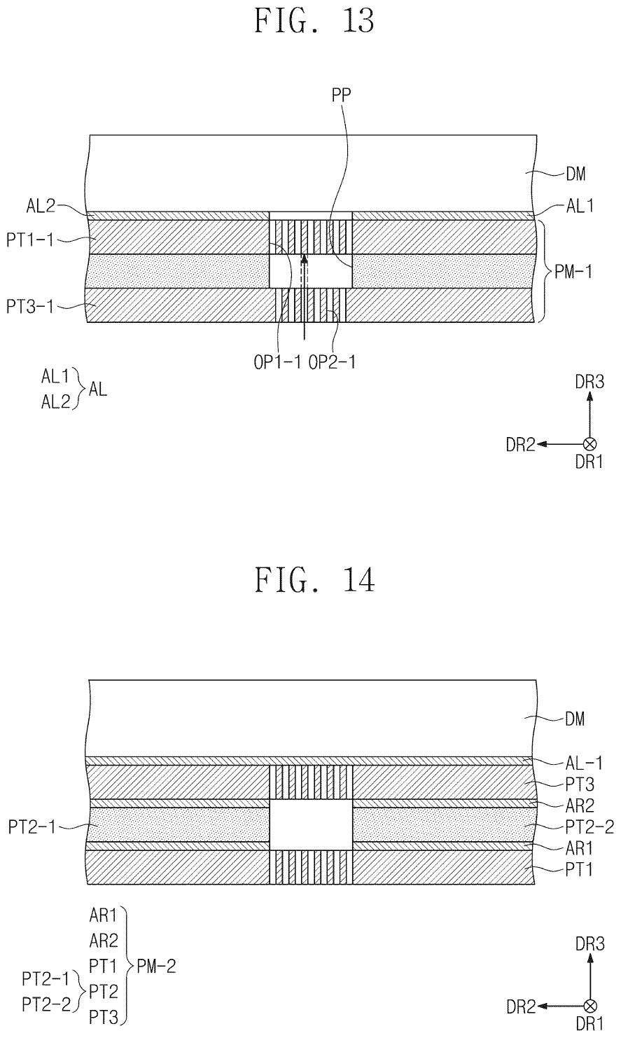

FIG. 14 is a cross-sectional view of a portion of an electronic device according to an embodiment of the present disclosure.

In FIG. 14, the same/similar reference numerals denote the same elements in FIGS. 1 to 11, and thus, detailed descriptions of the same elements will be omitted.

The electronic device according to the present embodiment may include a display module DM, a support plate PM-2 disposed under the display module DM, and a plate adhesive layer AL-1 disposed between the display module DM and the support plate PM-2.

The support plate PM-2 may include an upper plate PT1, an intermediate plate PT2, a lower plate PT3, a first interlayer adhesive layer AR1 disposed between the upper plate PT1 and the intermediate plate PT2, and a second interlayer adhesive layer AR2 disposed between the intermediate plate PT2 and the lower plate PT3.

When compared with the support plate PM described above with reference to FIG. 11, the support plate PM-2 according to the present embodiment further includes the first and second interlayer adhesive layers AL1 and AL2, and thus, a thickness of the support plate PM-2 may increase. However, the overall rigidity of the support plate PM-2 may be easily controlled by adjusting the types of first, second, and third metal materials.

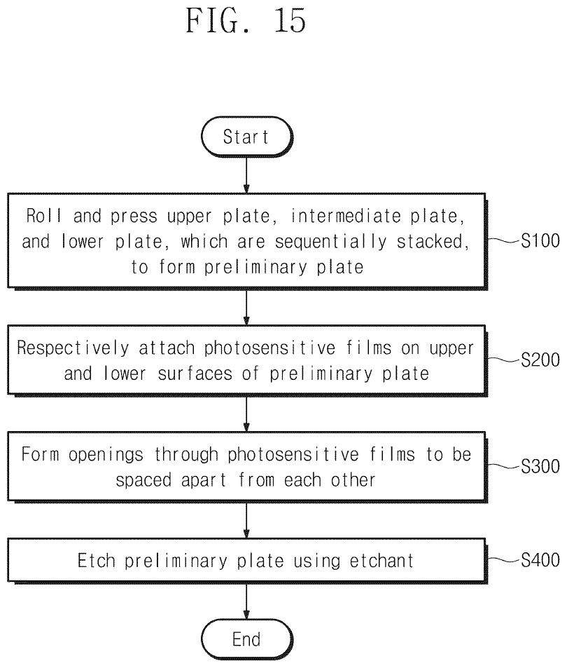

FIG. 15 is a flowchart describing a method of manufacturing the support plate according to an embodiment of the present disclosure.

A manufacturing method of the support plate may include rolling and pressing the upper plate including the first metal material, the intermediate plate including the second metal material different from the first metal material, and the lower plate including the third metal material different from the second metal material, which are sequentially stacked, to form a preliminary plate (S100), attaching photosensitive films on upper and lower surfaces of the preliminary plate (S200), forming openings through the photosensitive films to be spaced apart from each other (S300), and etching the preliminary plate by using an etchant (S400).

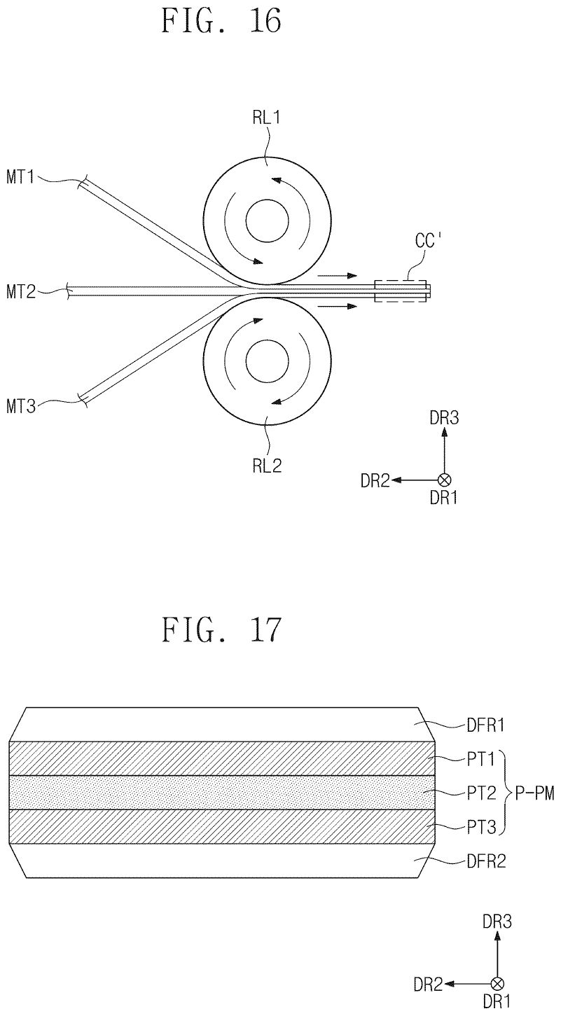

FIGS. 16 to 20 are views of steps of a method of manufacturing the support plate according to an embodiment of the present disclosure.

Hereinafter, steps of a manufacturing method of the support plate will be described with reference to FIGS. 16 to 20.

Referring to FIG. 16, a preliminary lower plate MT1 including the first metal material, a preliminary intermediate plate MT2 including the second metal material different from the first metal material, and a preliminary upper plate MT3 including the third metal material different from the second metal material may be sequentially stacked and rolled to form the preliminary plate S100.

Referring to FIG. 16, the preliminary third plate MT3, the preliminary second plate MT2, and the preliminary first plate MT1 may be sequentially stacked in the third direction DR3 and may pass between a first roller RL1 and a second roller RL2 to be rolled and pressed together. Accordingly, atomic diffusion bonding may occur between different types of metals, and thus, the clad metal may be formed

In the area CC′ in FIG. 16, the clad metal formed by rolling the first, second, and third plates MT1, MT2, and MT3 is shown as a representative example. The clad metal may have the thickness smaller than the combined thickness of the stacked first, second, and third plates MT1, MT2, and MT3.

The forming of the preliminary plate (S100) may further include cutting the clad metal to form the preliminary plate P-PM.

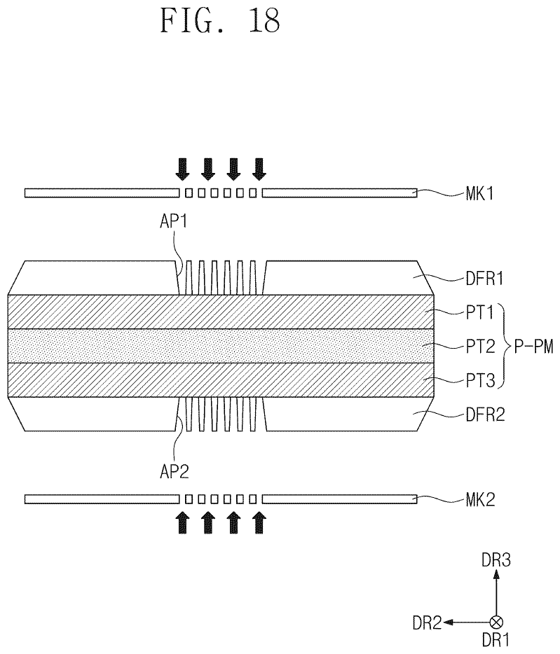

Then, referring to FIGS. 17 and 18, a first photosensitive film DFR1 may be attached to an upper surface of the preliminary plate P-PM, and a second photosensitive film DFR2 may be attached to a lower surface of the preliminary plate P-PM. In one embodiment, the first and second photosensitive films DFR1 and DFR2 may be attached through a lamination process.

In the present embodiment, each of the first and second photosensitive films DFR1 and DFR2 may be, but are not limited to, a dry film photoresist.

The first and second photosensitive films DFR1 and DFR2 may include a photosensitive polymer material.

FIG. 18 shows a step of placing (or arranging) a first pattern mask MK1 above the first photosensitive film DFR1, placing (or arranging) a second pattern mask MK2 under the second photosensitive film DFR2, and exposing the first and second photosensitive films DFR1 and DFR2 through the first and second pattern masks MK1 and MK2. In this embodiment, the shape of each of the first openings OP1 and the second openings OP2 may be controlled by adjusting the shape of patterns of the first pattern mask MK1 and the second pattern mask MK2.

In the present embodiment, portions of the photosensitive films DFR1 and DFR2 that are exposed to an ultraviolet light may be cured; however, the present disclosure is not limited thereto or thereby. FIG. 18 illustrates a positive photoresist process to cure portions exposed to the ultraviolet light and to remove portions not exposed to the ultraviolet light by a solvent as a representative example, however, a negative photoresist process to remove the portions exposed to the ultraviolet light and to cure the portions not exposed to the ultraviolet light may be performed.

First film openings AP1 may be formed through the first photosensitive film DFR1, and the second film openings AP2 may be formed through the second photosensitive film DFR2.

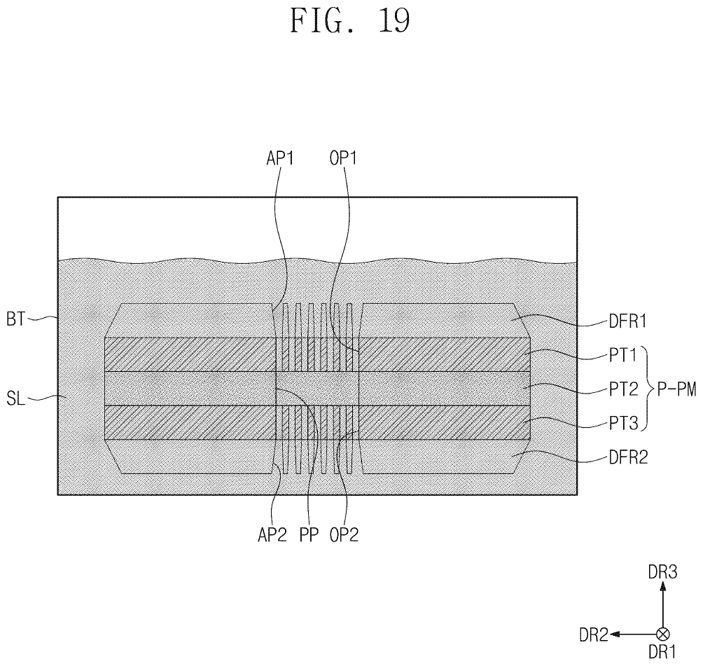

Positions at where the first film openings AP1 are formed may correspond to positions where the first openings OP1 (see, e.g., FIG. 19) are formed, and positions where the second film openings AP2 are formed may correspond to positions where the second openings OP2 (see, e.g., FIG. 19) are formed.

Referring to FIG. 19, the preliminary plate may be etched by using the etchant (S400). FIG. 19 illustrates a structure in which the first openings OP1 are formed through the upper plate PT1, the second openings OP2 are formed through the lower plate PT3, and the penetration portion PP is formed through the intermediate plate PT2 by the etching of the preliminary plate P-PM (S400).

The etching of the preliminary plate (S400) may be performed by a wet etching process.

The etching of the preliminary plate (S400) may include immersing the preliminary plate P-PM into an etchant SL in a water tank BT containing the etchant SL.

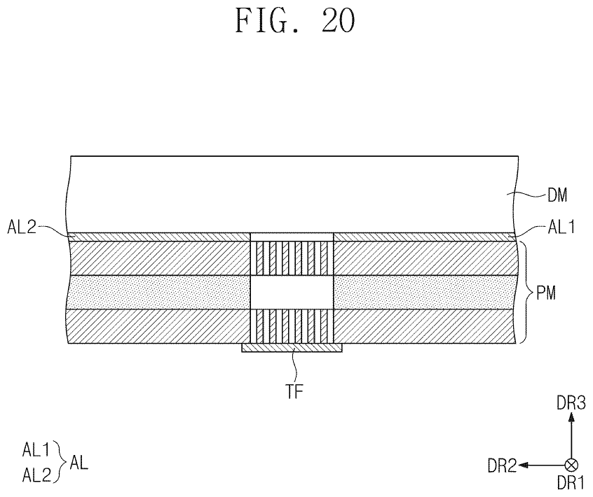

FIG. 19 illustrates the immersing of the preliminary plate P-PM into the etchant SL to perform the etching process. FIG. 20 illustrates the display module DM and the support plate PM manufactured through the manufacturing method and disposed under the display module DM.

Referring to FIGS. 19 and 20, the intermediate plate PT2 may be etched more easily by the etchant SL than the upper plate PT1 and the lower plate PT3.

The upper plate PT1 may be etched by the etchant SL provided through the first film openings AP1, and thus, the first openings OP1 corresponding to the first film openings AP1 may be formed through the upper plate PT1. The lower plate PT3 may be etched by the etchant SL provided through the second film openings AP2, and thus, the second openings OP2 corresponding to the second film openings AP2 may be formed through the lower plate PT3.

In this case, an etch rate of the second metal material with respect to the etchant SL may be greater than an etch rate of the first metal material with respect to the etchant SL and an etch rate of the third metal material with respect to the etchant SL. In various embodiments, the etchant may be sulfuric acid, hydrochloric acid, iron chloride, sodium hydroxide, or a solution containing a mixture thereof, which may etch metal. When the second metal material is aluminum and each of the first and third metal materials is stainless steel, the etch rate of the second metal material with respect to the etchant SL may be greater than the etch rate of each of the first and third metal materials with respect to the etchant SL.

For example, the etchant provided through the first openings OP1 and the second openings OP2 may etch the intermediate plate PT2 more than the upper and lower plates PT1 and PT3, and thus, the penetration portion PP may be formed in the intermediate plate PT2.

According to the manufacturing method of the support plate according to embodiments of the present disclosure, because the preliminary plate P-PM is formed by using the clad metal and the first and second openings OP1 and OP2 and the penetration portion PP are concurrently (or simultaneously) formed, the manufacturing process of the support plate PM may be significantly simplified. Therefore, the manufacturing cost and time for the electronic device may be reduced.

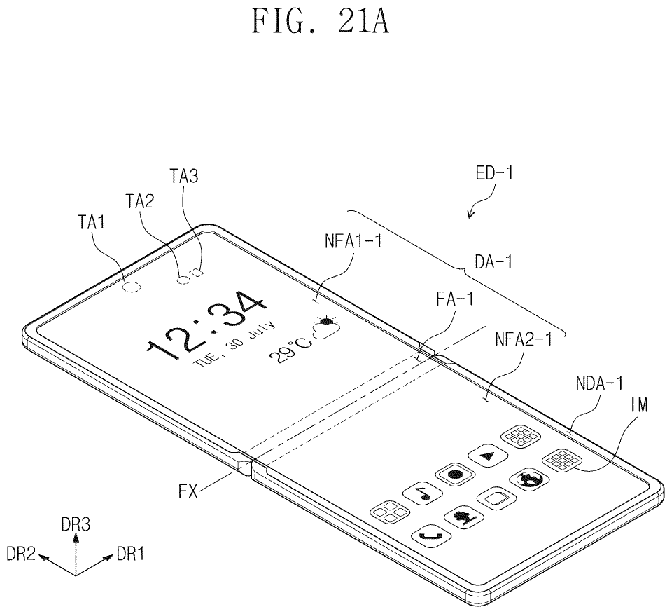

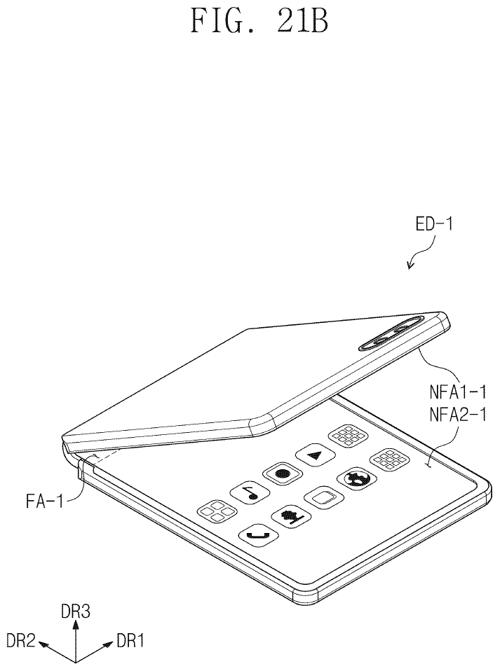

FIGS. 21A and 21B are perspective views of an electronic device ED-1 according to an embodiment of the present disclosure.

FIGS. 21A and 21B are perspective views of the electronic device ED-1 according to an embodiment of the present disclosure. FIG. 21A is a perspective view of the electronic device ED-1 in an unfolded state, and FIG. 21B is a perspective view of the electronic device ED-1 in a folded state. Different from the electronic device ED described above with reference to FIGS. 1A to 1C, the electronic device ED-1 may have a folding axis FX parallel to a minor axis direction. In FIGS. 21A and 21B, the same/similar reference numerals denote the same elements in FIGS. 1 to 20, and thus, detailed descriptions of the same elements will be omitted.

The electronic device ED-1 may display an image through a display area DA-1. When the electronic device ED-1 is in the unfolded state, the display area DA-1 may include a plane defined by a first direction DR1 and a second direction DR2. A thickness direction of the electronic device ED-1 may be parallel to a third direction DR3 crossing (e.g., intersecting) the first direction DR1 and the second direction DR2. Accordingly, a front surface (e.g., an upper surface) and a rear surface (e.g., a lower surface) of each member of the electronic device ED-1 may be defined with respect to the third direction DR3. The electronic device ED-1 may have a minor axis extending in the first direction DR1 and a major axis extending in the second direction DR2.

The display area DA-1 may include a first non-folding area NFA1-1, a folding area FA-1, and a second non-folding area NFA2-1. The electronic device ED-1 may be folded in the folding area FA-1 with respect to the folding axis FX extending in the first direction DR1.

The electronic device ED-1 may be inwardly folded (referred to as in-folding) to allow the first non-folding area NFA1-1 to face the second non-folding area NFA2-1. Accordingly, when the electronic device ED-1 is completely folded, the display area DA-1 may not be exposed to the outside of the electronic device ED-1; however, the present disclosure is not limited thereto or thereby. In another embodiment, the electronic device ED-1 may be outwardly folded (referred to as out-folding) to allow the first non-folding area NFA1-1 to be opposite to the second non-folding area NFA2-1.

The electronic device ED-1 may be operated in only one of the in-folding operation or the out-folding operation. According to an embodiment, the electronic device ED-1 may be operated in both the in-folding operation and the out-folding operation. In such an embodiment, the folding area FA-1 of the electronic device ED-1 may be inwardly folded (in-folding) and outwardly folded (out-folding). According to an embodiment, a portion of the electronic device ED-1 may be inwardly folded and another portion of the electronic device ED-1 may be outwardly folded.

FIGS. 21A and 21B illustrate an embodiment of the electronic device ED-1 including one folding area FA-1 and two non-folding areas NFA1-1 and NFA2-1 as a representative example; however, the number of folding areas and the number of non-folding areas is not limited thereto or thereby. As an example, the electronic device ED-1 may include three or more non-folding areas and a plurality of folding areas disposed between the non-folding areas adjacent to each other.

The electronic device ED-1 may include a plurality of sensing areas TA1, TA2, and TA3 defined therein. FIG. 21A illustrates an embodiment having three sensing areas TA1, TA2, and TA3 as a representative example; however, the number of the sensing areas TA1, TA2, and TA3 is not limited thereto or thereby.

The sensing areas TA1, TA2, and TA3 may include a first sensing area TA1, a second sensing area TA2, and a third sensing area TA3. As an example, the first sensing area TA1 may overlap a camera module, and the second sensing area TA2 and the third sensing area TA3 may overlap a proximity illumination sensor; however, the present disclosure is not limited thereto or thereby.

The electronic device ED-1 may include a plurality of electro-optical modules. Each of electro-optical modules ELM may receive an external input through the first sensing area TA1, the second sensing area TA2, or the third sensing area TA3 or may output signals through the first sensing area TA1, the second sensing area TA2, or the third sensing area TA3.

The first sensing area TA1, the second sensing area TA2, and the third sensing area TA3 may be included in the display area DA-1. For example, the image may also be displayed through the first sensing area TA1, the second sensing area TA2, and the third sensing area TA3. Each of the first sensing area TA1, the second sensing area TA2, and the third sensing area TA3 may have a transmittance higher than a transmittance of the other area of the display area DA-1. In addition, the transmittance of the first sensing area TA1 may be higher than each of the transmittance of the second sensing area TA2 and the transmittance of the third sensing area TA3; however, the present disclosure is not limited thereto or thereby. According to an embodiment, at least one of the first sensing area TA1, the second sensing area TA2, and the third sensing area TA3 may be defined in the non-display area NDA-1 rather than in the display area DA-1. An opening may be defined in at least one of the first sensing area TA1, the second sensing area TA2, and the third sensing area TA3.

According to an embodiment of the present disclosure, some of electronic modules may overlap the display area DA-1, and the other of the electronic modules may be surrounded by the display area DA-1. Therefore, the area to place the electronic modules does not need to be provided in the non-display area NDA-1 around the display area DA-1. As a result, an area ratio of the display area DA-1 to a front surface of the electronic device ED-1 may increase.

Although embodiments of the present disclosure have been described, it is understood that the present disclosure should not be limited to the described embodiments but various changes and modifications can be made by one ordinary skilled in the art within the spirit and scope of the present disclosure as hereinafter claimed. Therefore, the disclosed subject matter should not be limited to any single embodiment described herein, and the scope of the present disclosure shall be determined according to the attached claims and their equivalents.

What is claimed is:

1. An electronic device comprising:
a display module having a folding area and non-folding areas spaced apart from each other with the folding area therebetween, the display module comprising pixels; and
a support plate under the display module and comprising:
an upper plate having first openings spaced apart from each other and defined through a portion thereof overlapping the folding area;
a lower plate under the upper plate and having second openings spaced apart from each other and defined through a portion thereof overlapping the folding area; and
an intermediate plate between the upper plate and the lower plate and comprising first and second parts spaced apart from each other at the folding area and respectively overlapping the non-folding areas.

2. The electronic device of claim 1, wherein a side surface of the first part adjacent to the folding area and a side surface of the second part adjacent to the folding area face each other.

3. The electronic device of claim 1, wherein a lower surface of the upper plate and an upper surface of the lower plate face each other in the folding area, and
wherein the first part has a same thickness as the second part.

4. The electronic device of claim 1, wherein the intermediate plate does not overlap the folding area.

5. The electronic device of claim 1, wherein the first openings extend through an upper surface and a lower surface of the upper plate, and
wherein the second openings extend through an upper surface and a lower surface of the lower plate.

6. The electronic device of claim 1, wherein the lower plate comprises a first metal material, the intermediate plate comprises a second metal material, the upper plate comprises a third metal material, and
wherein the second metal material is different from the first metal material and the third metal material.

7. The electronic device of claim 6, wherein the first metal material and the third metal material comprise a same material.

8. The electronic device of claim 6, wherein each of the first metal material and the third metal material comprises stainless steel or titanium, and
wherein the second metal material comprises aluminum or copper.

9. The electronic device of claim 1, wherein the intermediate plate is directly on the lower plate, and
wherein the upper plate is directly on the intermediate plate.

10. The electronic device of claim 1, wherein a lower surface of the lower plate is flat at an area overlapping the non-folding areas.

11. The electronic device of claim 1, further comprising a plate adhesive layer between the display module and the support plate,
wherein the support plate is attached to a lower surface of the display module by the plate adhesive layer.

12. The electronic device of claim 11, wherein the plate adhesive layer covers the first openings.

13. The electronic device of claim 1, wherein the first openings do not overlap the second openings when viewed in a plane.

14. The electronic device of claim 1, further comprising:
a first intermediate adhesive layer between the lower plate and the intermediate plate; and
a second intermediate adhesive layer between the intermediate plate and the upper plate.

15. An electronic device comprising:
a display module having a folding area extending in a first direction when viewed in a plane and non-folding areas spaced apart from each other with the folding area therebetween in a second direction perpendicular to the first direction; and
a support plate comprising:
an upper plate having first openings defined through a portion thereof overlapping the folding area along a third direction perpendicular to the first and second directions;
a lower plate having second openings defined through a portion thereof overlapping the folding area along the third direction; and
an intermediate plate between the upper plate and the lower plate and having a penetration portion extending through a portion thereof overlapping the folding area in the first direction from one side surface of the intermediate plate to another side surface thereof.

16. The electronic device of claim 15, wherein the lower plate comprises a first metal material, the intermediate plate comprises a second metal material, the upper plate comprises a third metal material, and
wherein the second metal material is different from the first metal material and the third metal material.

17. The electronic device of claim 15, wherein the penetration portion has a rectangular shape when viewed from the one side surface.

18. A method of manufacturing a support plate, the method comprising:
forming a preliminary plate by sequentially stacking and pressing a preliminary upper plate comprising a first metal material, a preliminary intermediate plate comprising a second metal material different from the first metal material, and a preliminary lower plate comprising a third metal material different from the second metal material;
attaching photosensitive films on upper and lower surfaces of the preliminary plate, respectively;
forming film openings spaced apart from each other through the photosensitive films; and
etching the preliminary plate by using an etchant.

19. The method of claim 18, wherein an etch rate of the second metal material with respect to the etchant is greater than an etch rate of the first metal material with respect to the etchant and an etch rate of the third metal material with respect to the etchant.

20. The method of claim 18, wherein each of the first metal material and the third metal material comprises stainless steel or titanium, and
wherein the second metal material comprises aluminum or copper.
